(19) United States
(12) Patent Application Publication
(10) Pub. No.: US 2026/0351947 A1
(43) Pub. Date: Nov. 5, 2026

(54) DIGITAL EMERGENCY ELECTRIC SAFETY CONTROL SYSTEM

(71) Applicant: Technomirai Co., Ltd., Tokyo (JP)

(72) Inventor: Kazuo MIWA, Tokyo (JP)

(73) Assignee: Technomirai Co., Ltd., Tokyo (JP)

(21) Appl. No.: 19/714,220

(22) Filed: Jun. 19, 2026

Related U.S. Application Data
(63) Continuation of application No. PCT/JP2023/045887, filed on Dec. 21, 2023.

(51) Int. Cl. H02H 3/08; H02H 1/00; H02H 3/04

(52) U.S. Cl. CPC H02H 3/08; H02H 1/0007; H02H 3/04

(57) ABSTRACT

A digital emergency electric safety control system prevents and controls occurrence of an overcurrent that becomes a factor of electric burnout, electric fire, or the like, and takes necessary measures such as power interruption before electric burnout, electric fire, or the like occurs, by detecting an instantaneous current value in any given microsecond time in a range of 1/50,000 second (=20 μsec) to 1/100,000 second (=10 μsec) by using an alternating-current instantaneous current value detection device that is connected to a load-side electric path and detects an instantaneous current value that is a current value flowing through the load-side electric path at an instantaneous time.

### CROSS-REFERENCE TO RELATED APPLICATIONS

This application is a “by-pass” continuation application under 35USC 111(a) based on International Application PCT/JP2023/045887, filed Dec. 21, 2023, which is incorporated herein by reference in its entirety.

### BACKGROUND

### Technical Field

The present invention relates to a system that prevents occurrence of an electrical accident leading to a fire or the like in a power device in which a power-source-side electric path from a power source side and a load-side electric path toward a load are electrically connected via an electrical device or the like disposed in a housing, and further prevents occurrence of an accident such as damage of various power/electrical devices and apparatuses to which the load-side electric path is connected.

### Related Art

The applicant of the present application has already implemented a digital electric safety control system (Japanese Patent No. 6732278), “DESCON”, which is a system for preventing occurrence of an electrical accident leading to a fire when a power-source-side electric path from a power source side is electrically connected to a load-side electric path toward a load that operates by receiving supply of electric power, such as lighting equipment/devices, air conditioning equipment/devices, freezing and refrigeration equipment/devices, and production equipment/devices via a power device such as power receiving and transforming equipment, a switchboard, a distribution board, a lighting panelboard, a power panelboard, a control panel, and a junction box that are provided with an electrical device such as a main breaker and a leakage breaker.

The applicant of the present application has proposed a “digital electric safety control system” (Japanese Patent No. 6836234) which is a system that prevents occurrence of an electrical accident leading to a fire or the like in a power device such as a switchboard, a distribution board, a lighting panelboard, a power panelboard, a control panel, and a junction box, in which a power-source-side electric path from a power source side and a load-side electric path toward a load are electrically connected via an electrical device or the like disposed in a housing, and further prevents occurrence of an accident such as damage of various power/electrical devices and apparatuses to which the load-side electric path is connected.

The applicant of the present application has proposed a system, named a “DESCON operation safety system” (Japanese Patent No. 6991636), which can automatically perform ON/OFF switching of each of a plurality of loads to which a load-side electric path is connected, automatically check a meter for a power usage amount in the load and automatically calculate the power usage amount, to save labor, and further prevent occurrence of an electrical accident leading to a fire by detecting bolt looseness in a bolt screw tightening connection portion in a power device, insufficient insertion into a receptacle, and leakage due to dust adhesion in the bolt screw tightening connection portion.

### SUMMARY

The applicant of the present application has implemented the “digital electric safety control system” patented in Japanese Patent No. 6732278, named “DESCON”, and evolved the “digital electric safety control system” of Japanese Patent No. 6732278 to obtain a patent for the “digital electric safety control system” of Japanese Patent No. 6836234. Further, the applicant of the present application has obtained a patent for the “DESCON operation safety system” in Japanese Patent No. 6991636, which is an invention obtained by evolving the “digital electric safety control system” patented in Japanese Patent No. 6732278 and the “digital electric safety control system” of Japanese Patent No. 6836234, and has completed the “digital emergency electric safety control system” of the present application by further conducting studies.

The applicant of the present application is preparing to provide the “digital emergency electric safety control system” according to the present invention to society under the name of “DESCON emergency system”.

An invention according to the “digital emergency electric safety control system”, that is, the “DESCON emergency system” according to the invention of the present application is to prevent and control occurrence of an overcurrent that becomes a factor of electric burnout, electric fire, or the like and take necessary measures such as power interruption before electric burnout, electric fire, or the like occurs, by detecting an instantaneous current value in any given microsecond time in a range of 1/50,000 second (=20 μsec) to 1/100,000 second (=10 μsec) by using an alternating-current instantaneous current value detection device that is connected to a load-side electric path and detects an instantaneous current value that is a current value flowing through the load-side electric path at an instantaneous time. The invention can be exemplified as follows.

[1]

A digital emergency electric safety control system including:
a power device in which a power-source-side electric path from a power source side and a load-side electric path toward a load are electrically connected via an electrical device disposed in a housing;
an alternating-current instantaneous current value detection device that is connected to the load-side electric path and detects an instantaneous current value that is a current value flowing through the load-side electric path at an instantaneous time;
an instantaneous current value determination device that compares the detected instantaneous current value with an allowable current value range that is a current value range allowed in advance for the load-side electric path in which the instantaneous current value has been detected in accordance with a cable size of the load-side electric path in which the instantaneous current value has been detected;
a power supply automatic interruption determination unit that determines whether the load to which a current is supplied via the load-side electric path in which it is determined that an instantaneous current exceeding the allowable current value range is flowing is an automatically interruptible power supply load when a time in which an instantaneous current exceeding the allowable current value range flows reaches an allowable protection operation time, with reference to the allowable protection operation time when the instantaneous current value determination device determines that the allowable current value range is exceeded, the allowable protection operation time being a protection operation time allowed for an energization circuit breaker that interrupts energization to the load-side electric path in which it is determined that an instantaneous current exceeding the allowable current value range is flowing;
a first power supply interruption device that causes the energization circuit breaker to perform a process of interrupting energization to the load-side electric path in which it is determined that an instantaneous current exceeding the allowable current value range is flowing, in order to interrupt power supply to the load determined to be an automatically interruptible power supply load by the power supply automatic interruption determination unit; and
a second power supply interruption device that interrupts, when the power supply automatic interruption determination unit determines that the load is not an automatically interruptible power supply load, power supply to a load device controller controlling the load determined not to be an automatically interruptible power supply load, and then causes the energization circuit breaker to perform a process of interrupting energization to the load-side electric path in which it is determined that an instantaneous current exceeding the allowable current value range is flowing.
   [2]

The digital emergency electric safety control system according to [1], further including:
a first alert notification information output unit that outputs first alert notification information together with information for specifying the power device related to the housing, to an administrator terminal used by an administrator who manages the power device and an operator terminal owned by an operator who is in charge of management of the power device, when the instantaneous current value determination device determines that the allowable current value range is exceeded.
   [3]

The digital emergency electric safety control system according to [1] or [2], further including:
a second alert notification information output unit that outputs second alert notification information together with information for specifying the power device related to the housing, to an administrator terminal used by an administrator who manages the power device and an operator terminal owned by an operator who is in charge of management of the power device,
when a time in which an instantaneous current exceeding the allowable current value range flows reaches an allowable protection operation time, with reference to the allowable protection operation time when the instantaneous current value determination device determines that the allowable current value range is exceeded, the allowable protection operation time being a protection operation time allowed for an energization circuit breaker that interrupts energization to the load-side electric path in which it is determined that an instantaneous current exceeding the allowable current value range is flowing.
   [4]

The digital emergency electric safety control system according to [1], [2], or [3], in which the instantaneous time is any given microsecond time in a range of 1/50,000 second (=20 μsec) to 1/100,000 second (=10 μsec).

According to the present invention, it is possible to provide a system that prevents occurrence of an electrical accident leading to a fire or the like in a power device in which a power-source-side electric path from a power source side and a load-side electric path toward a load are electrically connected via an electrical device or the like disposed in a housing, and further prevents occurrence of an accident such as damage of various power/electrical devices and apparatuses to which the load-side electric path is connected.

In particular, it is possible to provide a system capable of preventing and controlling occurrence of an overcurrent that becomes a factor of electric burnout, electric fire, or the like and taking necessary measures such as power interruption before electric burnout, electric fire, or the like occurs.

### BRIEF DESCRIPTION OF DRAWINGS

FIG. 1 is a diagram illustrating a part of an outline of an overall configuration of a digital emergency electric safety control system of the present invention, and is a conceptual diagram, in which a part thereof is omitted, illustrating a state in which a DESCON system central device including a server device constituted by a computer is connected with a high-voltage power reception board and a capacitor board of a cubicle to be managed and controlled so as to enable mutual communication of information via a wired or wireless network such as the Internet and a dedicated line.

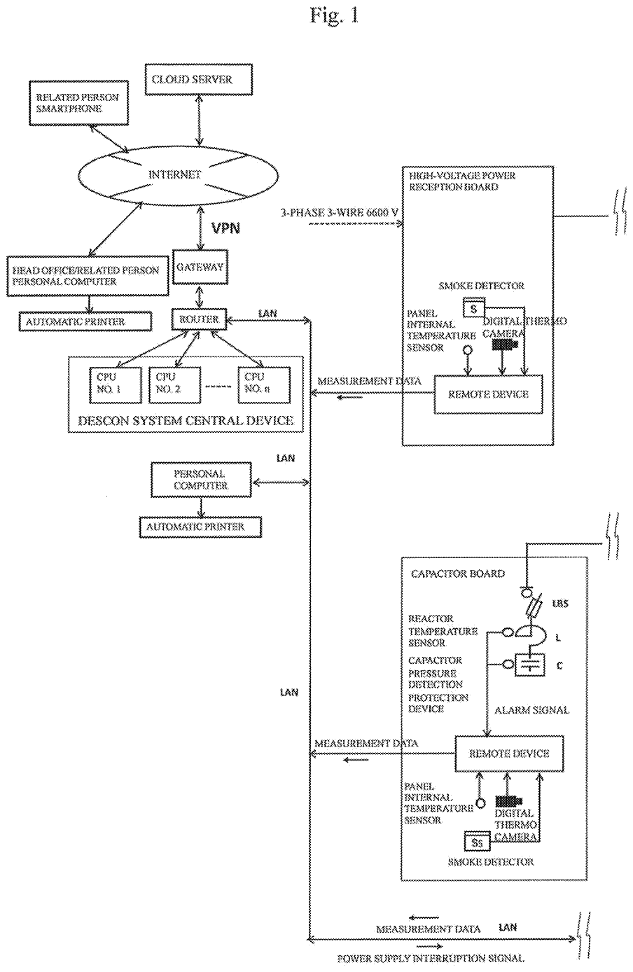

### DETAILED DESCRIPTION

A digital emergency electric safety control system of the present invention of the present application, that is called as “DESCON emergency system” or simply called as “DESCON ” includes a power device, an alternating-current instantaneous current value detection device, an instantaneous current value determination device, a first alert notification information output unit, a power supply automatic interruption determination unit, a first power supply interruption device, a second power supply interruption device, a housing internal temperature information acquisition unit, an electric path temperature information acquisition unit, a housing internal temperature monitoring unit, a load-side electric path temperature information monitoring unit, a second alert notification information output unit, and a third alert notification information output unit.

In the power device, a power-source-side electric path from a power source side and a plurality of load-side electric paths branched from the power-source-side electric path and directed to a plurality of loads are electrically connected in a housing, a first electrical device is interposed in the power-source-side electric path in the housing, and second electrical devices are interposed in the plurality of load-side electric paths in the housing. The first electrical device interposed in the power-source-side electric path and the plurality of second electrical devices interposed in the plurality of load-side electric paths are both disposed in the housing.

Examples of such a power device include, for example, various types of power receiving and transforming equipment, a switchboard, a distribution board, a lighting panelboard, a power panelboard, a control panel, a remote control panel, and a junction box for branch wiring connection of an extension cord or a wiring line between devices/instruments and the switchboard, a distribution board, or the like.

The first electrical device is disposed in the housing included in the above-described power device and electrically connects the power-source-side electric path from the power source side and the load-side electric path toward the load. Examples of the first electrical device include a main breaker and a leakage breaker.

The plurality of second electrical devices are circuit switches of a type different from the main breaker, the leakage breaker, and the like described above. Examples of the circuit switches include a magnet switch, a power relay, and a solid state relay.

Examples of the load toward which the load-side electric path is directed include: power/electric apparatuses and devices that operate by receiving power supply, such as a prime mover, an elevator, air conditioning equipment, ventilation equipment, lighting equipment, a refrigerating/freezing case, a refrigerator/freezer, a measuring instrument, a computer device, a monitoring camera, a medical device, and a communication apparatus that are disposed and used regardless of whether inside or outside a building; power/electric apparatuses and devices and communication apparatuses and devices disposed and used in vehicles and moving means such as trains, cars, airplanes, and ships; and receptacles to which these are connected.

These loads are connected to a distal end side of each of the plurality of load-side electric paths.

The alternating-current instantaneous current value detection device is connected to the load-side electric path described above, and detects an instantaneous current value that is a current value flowing through the load-side electric path at an instantaneous time.

As an alternating-current instantaneous current value detection device, a current sensor using an instrument current transformer called a current transformer (CT) can be adopted.

Units of the instantaneous time in the detection at the instantaneous time are, for example, 1/12,000 seconds=83 microseconds, and can be freely set between 1/50,000 seconds (=20 μsec) and 1/100,000 seconds (=10 μsec). In addition, within this range, the instantaneous time can also be set to microseconds according to a performance of a computer (PC) included in the DESCON emergency system.

It is advantageous to set the units of the instantaneous time in the detection at the instantaneous time to the microseconds between 1/50,000 seconds (=20 μsec) and 1/100,000 seconds (=10 μsec), in order to prevent and control occurrence of an overcurrent that becomes a factor of electric burnout, electric fire, or the like and take necessary measures such as power interruption before electric burnout, electric fire, or the like occurs.

The instantaneous current value determination device compares the detected instantaneous current value with an allowable current value range that is a current value range allowed in advance for the load-side electric path in which the instantaneous current value has been detected in accordance with a cable size of the load-side electric path in which the instantaneous current value has been detected.

For example, for a current value allowed in advance for the load-side electric path in which the instantaneous current value has been detected in accordance with the cable size of the load-side electric path in which the instantaneous current value has been detected, for example, less than 1.25 times a rated current set for the load-side electric path of the cable size can be set as an allowable current value range that is a current value range allowed in advance.

The instantaneous current value determination device in a server computer device acquires information detected by the above-described alternating-current instantaneous current value detection device via a wired or wireless network between the server computer device and the alternating-current instantaneous current value detection device, and performs the above-described processing under a predetermined computer program.

The power supply automatic interruption determination unit determines whether the load to which a current is supplied via the load-side electric path in which it is determined that an instantaneous current exceeding the allowable current value range is flowing is an automatically interruptible power supply load when a time in which an instantaneous current exceeding the allowable current value range flows reaches an allowable protection operation time, with reference to the allowable protection operation time when the instantaneous current value determination device determines that the allowable current value range is exceeded. The allowable protection operation time is a protection operation time allowed for an energization circuit breaker that interrupts energization to the load-side electric path in which it is determined that an instantaneous current exceeding the allowable current value range is flowing.

The power supply automatic interruption determination unit in the server computer device performs the above-described processing under a predetermined computer program.

The first power supply interruption device causes the energization circuit breaker to perform a process of interrupting energization to the load-side electric path in which it is determined that an instantaneous current exceeding the allowable current value range is flowing, in order to interrupt power supply to the load determined to be an automatically interruptible power supply load by the power supply automatic interruption determination unit.

The second power supply interruption device interrupts, when the power supply automatic interruption determination unit determines that the load is not an automatically interruptible power supply load, power supply to a load device controller controlling the load determined not to be an automatically interruptible power supply load, and then causes the energization circuit breaker to perform a process of interrupting energization to the load-side electric path in which it is determined that an instantaneous current exceeding the allowable current value range is flowing.

The first power supply interruption device and the second power supply interruption device in the server computer device perform the above-described processing under a predetermined computer program, and transmit interruption instruction information to the above-described energization circuit breaker and load device controller (for example, a computer) via a wired or wireless network disposed between the server computer device and the above-described energization circuit breaker and load device controller, to cause the above-described processing operation to be executed.

The digital emergency electric safety control system described above further includes: a first alert notification information output unit that outputs first alert notification information together with information for specifying the power device related to the housing, to an administrator terminal used by an administrator who manages the power device and an operator terminal owned by an operator who is in charge of management of the power device, when the instantaneous current value determination device determines that the allowable current value range is exceeded.

The digital emergency electric safety control system described above further includes: a second alert notification information output unit that outputs second alert notification information together with information for specifying the power device related to the housing, to an administrator terminal used by an administrator who manages the power device and an operator terminal owned by an operator who is in charge of management of the power device
when a time in which an instantaneous current exceeding the allowable current value range flows reaches an allowable protection operation time, with reference to the allowable protection operation time when the instantaneous current value determination device determines that the allowable current value range is exceeded, in which the allowable protection operation time is a protection operation time allowed for an energization circuit breaker that interrupts energization to the load-side electric path in which it is determined that an instantaneous current exceeding the allowable current value range is flowing.

The above-described first alert notification information output unit and second alert notification information output unit in the server computer device perform the above-described processing under a predetermined computer program, and the above-described first alert notification information and second alert notification information are output to the above-described administrator terminal and operator terminal connected to the server computer device via a wired or wireless network.

In the digital emergency electric safety control system described above, the instant time may be any given microsecond time between 1/50,000 seconds (=20 μsec) and 1/100,000 seconds (=10 μsec).

For example, detection in a very short time can be instantaneous detection at 1/12,000 seconds=83 microseconds. Here, 12,000 is a common multiple of 50 HZ and 60 HZ, for example.

This is advantageous for preventing and controlling occurrence of an overcurrent that becomes a factor of electric burnout, electric fire, or the like and taking necessary measures such as power interruption before electric burnout, electric fire, or the like occurs.

The administrator terminal can be configured by a personal computer or the like including an image information display unit such as a monitor. The operator terminal can be configured by a portable terminal such as a smartphone in which an application for operating the system of the present invention is downloaded.

The administrator terminal and the operator terminal are connected via a communication network such as the Internet or a dedicated line so as to be able to communicate information with a computer system including a server computer and the like included in the digital emergency electric safety control system of the present invention.

Although not illustrated, the computer system including the server computer and the like included in the digital emergency electric safety control system of the present invention is configured by a computer including: a CPU that performs control such that various functions of the system of this embodiment are implemented according to an operating system, a predetermined computer program installed or downloaded, or the like; a ROM that stores an operating system, various computer programs, and the like, and functions as a storage unit that stores data necessary for the CPU to execute processing for each control; a RAM and a hard disk that store data necessary for the CPU to execute processing, and are also used as a work area in which information is appropriately rewritten by the CPU; an information input/output unit such as a communication interface; and the like, in which these are connected by a necessary bus line.

A system of such a computer executes processing operations performed by the alternating-current instantaneous current value detection device, the instantaneous current value determination device, the power supply automatic interruption determination unit, the first power supply interruption device, the second power supply interruption device, the first alert notification information output unit, the second alert notification information output unit, and the like described above.

The alternating-current instantaneous current value detection device, the instantaneous current value determination device, the power supply automatic interruption determination unit, the first power supply interruption device, the second power supply interruption device, the first alert notification information output unit, the second alert notification information output unit, and the like described above do not need to be all disposed in one apparatus or device.

For example, a mode may be adopted in which an apparatus/device having some of these configurations is disposed in the power device, and this apparatus/device is connected to another apparatus/device disposed away from the power device and including a computer having other configurations, so as to be able to communicate information via a wired or wireless network.

Alternatively, it is also possible to adopt a mode in which an apparatus/device having some of the configurations described above is disposed in the power device, and this apparatus/device is connected to another apparatus/device disposed away from the power device and including a computer having some of other configurations and another apparatus/device including a computer having remaining configurations among other configurations, so as to be able to communicate information via a wired or wireless network.

Although the embodiment of the present invention has been described above with reference to the accompanying drawings, the present invention is not limited to the above-described embodiment, and various modifications can be made within the technical scope understood from the description of the claims.

1. A digital emergency electric safety control system comprising:
a power device in which a power-source-side electric path from a power source side and a load-side electric path toward a load are electrically connected via an electrical device disposed in a housing;
an alternating-current instantaneous current value detection device that is connected to the load-side electric path and detects an instantaneous current value that is a current value flowing through the load-side electric path at an instantaneous time;
an instantaneous current value determination device that compares the detected instantaneous current value with an allowable current value range that is a current value range allowed in advance for the load-side electric path in which the instantaneous current value has been detected in accordance with a cable size of the load-side electric path in which the instantaneous current value has been detected;
a power supply automatic interruption determination unit that determines whether the load to which a current is supplied via the load-side electric path in which it is determined that an instantaneous current exceeding the allowable current value range is flowing is an automatically interruptible power supply load when a time in which an instantaneous current exceeding the allowable current value range flows reaches an allowable protection operation time, with reference to the allowable protection operation time when the instantaneous current value determination device determines that the allowable current value range is exceeded, the allowable protection operation time being a protection operation time allowed for an energization circuit breaker that interrupts energization to the load-side electric path in which it is determined that an instantaneous current exceeding the allowable current value range is flowing;
a first power supply interruption device that causes the energization circuit breaker to perform a process of interrupting energization to the load-side electric path in which it is determined that an instantaneous current exceeding the allowable current value range is flowing, in order to interrupt power supply to the load determined to be an automatically interruptible power supply load by the power supply automatic interruption determination unit; and
a second power supply interruption device that interrupts, when the power supply automatic interruption determination unit determines that the load is not an automatically interruptible power supply load, power supply to a load device controller controlling the load determined not to be an automatically interruptible power supply load, and then causes the energization circuit breaker to perform a process of interrupting energization to the load-side electric path in which it is determined that an instantaneous current exceeding the allowable current value range is flowing.

2. The digital emergency electric safety control system according to claim 1, further comprising:
a first alert notification information output unit that outputs first alert notification information together with information for specifying the power device related to the housing, to an administrator terminal used by an administrator who manages the power device and an operator terminal owned by an operator who is in charge of management of the power device, when the instantaneous current value determination device determines that the allowable current value range is exceeded.

3. The digital emergency electric safety control system according to claim 1, further comprising:
a second alert notification information output unit that outputs second alert notification information together with information for specifying the power device related to the housing, to an administrator terminal used by an administrator who manages the power device and an operator terminal owned by an operator who is in charge of management of the power device
when a time in which an instantaneous current exceeding the allowable current value range flows reaches an allowable protection operation time, with reference to the allowable protection operation time when the instantaneous current value determination device determines that the allowable current value range is exceeded, the allowable protection operation time being a protection operation time allowed for an energization circuit breaker that interrupts energization to the load-side electric path in which it is determined that an instantaneous current exceeding the allowable current value range is flowing.

4. The digital emergency electric safety control system according to claim 1, wherein the instantaneous time is any given microsecond time in a range of 1/50,000 second (=20 μsec) to 1/100,000 second (=10 μsec).
